(19) United States
(12) Patent Application Publication
(10) Pub. No.: US 2014/0291029 A1
(43) Pub. Date: Oct. 2, 2014

(54) Beneficiated Clay Viscosifying Additives

(71) Applicant: HALLIBURTON ENERGY SERVICES, INC., Houston, TX (US)

(72) Inventors: Thomas S. Cortner, Houston, TX (US); Charles R. Landis, Houston, TX (US); Eric B. Frantz, Houston, TX (US)

(73) Assignee: Halliburton Energy Services, Inc., Houston, TX (US)

(21) Appl. No.: 13/853,423

(22) Filed: Mar. 29, 2013

(51) Int. Cl. C09K 8/035; E21B 7/00

(52) U.S. Cl. CPC C09K 8/035; E21B 7/00
USPC 175/65; 507/110; 507/112; 507/119; 507/120

(57) ABSTRACT

Beneficiated clay viscosifying additives may include a low-quality clay and a polymer coated high-quality clay that comprises a high-quality clay at least partially coated with a polymer, wherein the ratio of low-quality clay to high-quality clay is about 90:10 to about 80:20 by weight. Such beneficiated clay viscosifying additives may be used in drilling fluids.

### BACKGROUND

The present invention relates to beneficiated clay viscosifying additives, and methods relating thereto.

Swellable clays, also referred to herein as clays, are a major component of aqueous-based drilling fluids. Swellable clays provide several functions including lubricating and cooling the drill bit, viscosifying the fluid, controlling fluid loss by forming a filter cake along the wellbore, and suspending drilled solids. There are several types of clays (e.g., bentonite, kaolin, and Fuller's earth) that have varying levels of performance in each of these functions. Further, within an individual type of clay the performance in each of these functions can vary based on the source of the clay, e.g., Wyoming bentonite versus Arkansas bentonite.

In some instances, the quality of the clay may be enhanced (i.e., beneficiated) through extrusion methods, aging methods, and the like. Extrusion involves mechanically shearing the clay through a grinder (similar to a meat grinder), which is expensive and sensitive to conditions like moisture levels, feed rate, and die size. Further, there are no easily identified qualities of the original clay that allow for predicting the extent of the quality enhancement or if quality enhancement will occur.

Aging involves exposing the clay to sun for several months, which sounds straightforward, but given the volumes, e.g., 80,000 ton piles, mixing the clay to provide evenly aged clay is energy intensive and may yield variable results. Further, the cost and space of inventorying clay can be high and requires predictive business modeling to have clay at the right level of aging when needed. Because of these drawbacks, the current methods for beneficiating low-quality clay are used sparingly. As such, drilling fluids use higher concentrations of low-quality clay, which increases costs and decreases the carrying capacity of the drilling fluid (e.g., the amount of cuttings that can be removed from the wellbore during drilling).

### SUMMARY OF THE INVENTION

The present invention relates to beneficiated clay viscosifying additives, and methods relating thereto.

One embodiment of the present invention provides for a beneficiated clay viscosifying additive that includes a low-quality clay; a polymer coated high-quality clay that comprises a high-quality clay at least partially coated with a polymer; and wherein the ratio of low-quality clay to high-quality clay is about 90:10 to about 80:20 by weight.

Another embodiment of the present invention provides for a beneficiated clay viscosifying additive that includes a low-quality clay having an

Fe3+:Fe2+ ratio of less than about 1; a polymer coated high-quality clay that comprises a high-quality clay at least partially coated with a polymer, the high-quality clay having an Fe3+:Fe2+ ratio of about 1 or greater; wherein the high-quality clay has an average particle size less than an average particle size of the low-quality clay; and wherein the ratio of low-quality clay to high-quality clay is about 90:10 to about 80:20 by weight.

Yet another embodiment of the present invention provides for a method that includes dry coating a high-quality clay with a polymer to yield a polymer coated high-quality clay; and mixing the polymer coated high-quality clay with a low-quality clay to yield a beneficiated clay viscosifying additive, wherein the low-quality clay and the high-quality clay are at about 90:10 to about 80:20 by weight.

The features and advantages of the present invention will be readily apparent to those skilled in the art upon a reading of the description of the preferred embodiments that follows.

### DETAILED DESCRIPTION

The present invention relates to beneficiated clay viscosifying additives, and methods relating thereto.

The beneficiated clay viscosifying additives described herein comprising low-quality clays and polymer coated high-quality clays provide for the production of treatment fluids with greater performance (e.g., lubricity, viscosity, and fluid loss control) than treatment fluids comprising the same components but produced by other methods.

Current methods and formulations can use at most about 30% to about 40% low-quality clay by weight of the total clay and still achieve the desired rheological properties in the drilling fluid. Additional low-quality clay reduces the rheological properties in the drilling fluid below the desired levels. In contrast, when produced with beneficiated clay viscosifying additives described herein, the rheological properties of the drilling fluid may achieve desired levels with the unexpectedly high concentration of low-quality clays, e.g., about 80%-90% by weight of the total clay. Such beneficiation may allow for reduction in the total amount of clay used, which, in turn, reduces material costs and transportation costs.

It should be noted that when “about” is provided herein at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

The beneficiated clay viscosifying additives described herein may, in some embodiments, comprise low-quality clays and polymer coated high-quality clays, wherein the ratio of low-quality clay to high-quality clay is about 90:10 to about 80:20 by weight. Generally, polymer coated high-quality clays comprise high-quality clays at least partially coated with a polymer as described herein. As used herein, the term “coating,” and the like, does not imply any particular degree of coating on a particulate. In particular, the terms “coat” or “coating” do not imply 100% coverage by the coating on a particulate.

A measure of a clay's viscosifying efficacy is barrel yield. As used herein, the term “barrel yield” refers to the number of oil field barrels (42 gallons) that would be produced with a ton of clay hydrated with deionized water so as to achieve an apparent viscosity of 15 cP. Low barrel yield clays require more clay to produce a barrel of treatment fluid than higher barrel yield clays. As used herein, the term “low-quality clay” refers to a clay characterized as having less than 180-barrel yield. As used herein, the term “high-quality clay” refers to a clay characterized as having 180-barrel yield or greater. It should be noted that 180-barrel yield is a total solids concentration of about 11 pounds per barrel. Therefore, high-quality clays are clays that achieve an apparent viscosity of 15 cP at a concentration of 11 pounds per barrel or less in water. It should also be noted that barrel yield is a characteristic of the clay and refers to a measurement of the clay in water and not the whole drilling fluid, the clay and a polymer in water, or the like.

In some embodiments, low-quality clays may have a clay fraction that has a Fe³⁺:Fe²⁺ ratio of less than about 1. As used herein, the term “clay fraction” refers to the clay portion of a composition and can be extracted as the <325-mesh fraction of a wet sieve separation. Examples of low-quality clays may include, but are not limited to, attapulgite, sepiolite, vermiculite, illite, muscovite, biotite, Fuller's earth, kaolinite, cookeite, bulk clay, halloysite, flint clay, montmorillonite, bentonite, and the like, and any combination thereof.

In some embodiments, high-quality clays may have a clay fraction that has a Fe³⁺:Fe²⁺ ratio of about 1 or greater. Examples of high-quality clays may include, but are not limited to, hectorite, montmorillonite, bentonite, and the like, and any combination thereof.

As illustrated in the examples of low-quality clays and high-quality clays, some clay minerals may have samples that can be low-quality or high-quality depending on, inter alia, the location of mining. For example, low-quality bentonite may come from Arkansas mines while high-quality bentonite may come from Wyoming mines. It should be noted that low-quality clay and high-quality clay, as described herein, are two distinct compositions even if both comprise the same mineral in general, i.e., low-quality bentonite and high-quality bentonite are different.

In some embodiments, the high-quality clays and the low-quality clays may independently have an average particle size ranging from a lower limit of about 1 micron, 5 microns, 10 microns, 20 microns, 37 microns, or 44 microns to an upper limit of about 80 microns, 60 microns, 44 microns, or 37 microns, wherein the average particle size may range from any lower limit to any upper limit and encompasses any subset therebetween. In some embodiments, the high-quality clay may be have a lower average particle size than the low-quality clay.

Polymers suitable for use in conjunction with the methods described herein may include, but are not limited to, polysaccharides, polyacrylamides, polyalkylacrylamides, polyacrylic acids, polyvinyl alcohols, polyanionic cellulose, and the like, any derivative thereof, and any combination thereof. In some instances, copolymers comprising at least one of the foregoing may be suitable. As used herein, the term “copolymer” encompasses polymers with two or more monomeric units, e.g., alternating copolymers, statistic copolymers, random copolymers, periodic copolymers, block copolymers (e.g., diblock, triblock, and so on), terpolymers, graft copolymers, branched copolymers, star polymers, and the like, or any hybrid thereof.

In some embodiments, the concentration of polymers may range from a lower limit of about 0.01%, 0.1%, or 1% by weight of the high-quality clay to an upper limit of about 5%, 4%, 3%, or 2% by weight of the high-quality clay, and wherein the concentration may range from any lower limit to any upper limit and encompasses any subset therebetween.

In some embodiments, the low-quality clay may be polymer coated with one of the polymers described herein.

In some embodiments, polymer coated high-quality clays may be a high-quality clay having been dry or wet coated with a polymer. Some embodiments may involve dry coating high-quality clays with a polymer to yield polymer coated high-quality clays; and mixing the polymer coated high-quality clays with low-quality clays such that the ratio of low-quality clay to high-quality clay is about 90:10 to about 80:20 by weight. Some embodiments may involve wet coating high-quality clays with a polymer to yield polymer coated high-quality clays; drying the polymer coated high-quality clays; and mixing the polymer coated high-quality clays with low-quality clays such that the ratio of low-quality clay to high-quality clay is about 90:10 to about 80:20 by weight.

In some embodiments, the beneficiated clay viscosifying additives described herein may further comprise an additive. Examples of additives may include, but are not limited to, flocculent polymers, flocculents, salts, weighting agents, inert solids, fluid loss control agents, emulsifiers, dispersion aids, corrosion inhibitors, emulsion thinners, emulsion thickeners, viscosifying additives, gelling agents, surfactants, particulates, proppants, gravel particulates, lost circulation materials, foaming agents, gases, pH control additives, breakers, biocides, crosslinkers, stabilizers, chelating agents, scale inhibitors, gas hydrate inhibitors, mutual solvents, oxidizers, reducers, friction reducers, clay stabilizing agents, and the like, and any combination thereof.

Some embodiments may involve mixing the beneficiated clay viscosifying additives described herein with an aqueous base fluid to yield a treatment fluid. In some embodiments, a treatment fluid may comprise an aqueous base fluid and the beneficiated clay viscosifying additives described herein.

Examples of aqueous base fluids may include, but are not limited to, fresh water, saltwater (e.g., water containing one or more salts dissolved therein), brine (e.g., saturated salt water), seawater, brackish water, and any combination thereof. Generally, the water may be from any source, provided that it does not contain components that might adversely affect the stability and/or performance of the drilling fluids described herein.

In some embodiments, the beneficiated clay viscosifying additives described herein may be present in a treatment fluid in an amount ranging from a lower limit of about 0.1 pounds per gallon (ppg), 1 ppg, or 5 ppg to an upper limit of about 20 ppg, 15 ppg, or 10 ppg, wherein the amount may range from any lower limit to any upper limit and encompasses any subset therebetween.

In some embodiments, a treatment fluid may have a density ranging from a lower limit of about 9 lb/gal, 12 lb/gal, or 15 lb/gal to an upper limit of about 20 lb/gal, 17 lb/gal, or 15 lb/gal, wherein the density may range from any lower limit to any upper limit and encompasses any subset therebetween.

Some embodiments may involve drilling at least a portion of a wellbore penetrating a subterranean formation with a drilling fluid comprising an aqueous base fluid and the beneficiated clay viscosifying additives described herein.

In some embodiments, the beneficiated clay viscosifying additives described herein may be used in other suitable application and related fluids, e.g., trenching fluids, excavation fluids for slurry walls, binders in iron ore pelletizing, soil remediation, carrier fluids for spread-on sealants, cosmetics, and the like.

Embodiments disclosed herein include:

A. a beneficiated clay viscosifying additive that includes a low-quality clay; a polymer coated high-quality clay that comprises a high-quality clay at least partially coated with a polymer; and wherein the ratio of low-quality clay to high-quality clay is about 90:10 to about 80:20 by weight;

B. a beneficiated clay viscosifying additive that includes a low-quality clay having an Fe3+:Fe2+ ratio of less than about 1; a polymer coated high-quality clay that comprises a high-quality clay at least partially coated with a polymer, the high-quality clay having an Fe3+:Fe2+ ratio of about 1 or greater; wherein the high-quality clay has an average particle size less than an average particle size of the low-quality clay; and wherein the ratio of low-quality clay to high-quality clay is about 90:10 to about 80:20 by weight;

C. a treatment fluid comprising the beneficiated clay viscosifying additive of Embodiments A or B;

D. a method that includes dry coating a high-quality clay with a polymer to yield a polymer coated high-quality clay; and mixing the polymer coated high-quality clay with a low-quality clay to yield a beneficiated clay viscosifying additive, wherein the low-quality clay and the high-quality clay are at about 90:10 to about 80:20 by weight; and

E. a method that includes producing a drilling fluid comprising the beneficiated clay viscosifying additive of Embodiments A, B, or D.

F. a method that includes drilling a wellbore with a drilling fluid comprising the beneficiated clay viscosifying additive of Embodiments A, B, or D.

Each of embodiments A, B, C, and D may have one or more of the following additional elements in any combination, unless already provided for: Element 1: the high-quality clay having an Fe³⁺:Fe²⁺ ratio of about 1 or greater; Element 2: the low-quality clay having an Fe³⁺:Fe²⁺ ratio of less than about 1; Element 3: the high-quality clay having an average particle size of about 1 micron to about 80 microns; Element 4: the high-quality clay having an average particle size less than an average particle size of the low-quality clay; Element 5: the low-quality clay and the high-quality clay together being present in the drilling fluid in a total amount ranging from about 0.1 pounds per barrel to about 20 pounds per barrel; Element 6: the drilling fluid having a density of about 9 lb/gal to about 20 lb/gal; Element 7: the polymer comprising at least one selected from the group consisting of a polysaccharide, a polyacrylamide, a polyalkylacrylamide, a polyacrylic acid, a polyvinyl alcohol, a polyanionic cellulose, any derivative thereof, a copolymer thereof, and any combination thereof; Element 8: the polymer coated high-quality clay being formed by dry coating the high-quality clay with the polymer; and Element 9: the high-quality clay being bentonite.

By way of non-limiting example, exemplary combinations applicable to A, B, C include: Element 1 in combination with Element 2; Elements 1 and 2 in combination with Element 3; Elements 1 and 2 in combination with Element 4; Element 3 in combination with Element 4; Element 5 in combination with any of the foregoing; Element 6 in combination with any of the foregoing; Element 7 in combination with any of the foregoing; Element 8 in combination with any of the foregoing; and Element 9 in combination with any of the foregoing.

To facilitate a better understanding of the present invention, the following examples of preferred or representative embodiments are given. In no way should the following examples be read to limit, or to define, the scope of the invention.

### EXAMPLES

### Example 1

A low-quality bentonite (“LQB”) (National Standard Bentonite available from Colony, Wyo. mine operated by Bentonite Performance Minerals) was tested in combination with a polymer (polyacrylate) and a polymer coated, high-quality bentonite (“HQB”) (325-mesh bentonite from a Wyoming mine dry coated with the polymer prior to addition to the LQB). Table 1 provides the composition of the three samples tested.

TABLE 1

| Sample | LQB | Polymer | HQB | Addition Procedure |
|---|---|---|---|---|
| I | 11.00 | — | — | Dry |
| II | 10.98 | 0.02 | — | Dry |
| III | 10.00 | 0.02 | 0.98 | Dry |

Each of the dry samples of Table 1 were added to water, and then the rheological data, gel strength, and fluid loss control data were then collected on the three samples. The rheological data (Table 2) illustrates that the use of a low-quality clay in combination with the polymer coated high-quality bentonite synergistically work together for the highest rheological data (i.e., the 600 rpm data, the plastic viscosity (“PV”), and the yield point (“YP”)) while maintaining high gel strength and high fluid loss control.

TABLE 2

| | | |
|---|---|---|
| I | II | III |

Rheological Data

| | | | | |
|---|---|---|---|---|
| 600 | rpm | 7 | 29 | 35 |
| 300 | rpm | 4 | 22 | 28 |
| 200 | rpm | 3 | 19 | 25 |
| 100 | rpm | 2 | 15 | 22 |
| 6 | rpm | 1 | 8 | 14 |
| 3 | rpm | 1 | 8 | 12.5 |

| | | | |
|---|---|---|---|
| PV | 3 | 7 | 7 |
| YP | 1 | 15 | 21 |

Gel Strength

| | | | | |
|---|---|---|---|---|
| 10 | s gel | 1 | 6 | 10 |
| 10 | min gel | 1 | 14 | 18 |

Fluid Loss Control

| | | | |
|---|---|---|---|
| Filtrate | 24.4 | 24.0 | 24.0 |

The exemplary beneficiated clay viscosifying additives disclosed herein may directly or indirectly affect one or more components or pieces of equipment associated with the preparation, delivery, recapture, recycling, reuse, and/or disposal of the disclosed beneficiated clay viscosifying additives. For example, the disclosed beneficiated clay viscosifying additives may directly or indirectly affect one or more mixers, related mixing equipment, mud pits, storage facilities or units, fluid separators, heat exchangers, sensors, gauges, pumps, compressors, and the like used to generate, store, monitor, regulate, and/or recondition the exemplary beneficiated clay viscosifying additives. The disclosed beneficiated clay viscosifying additives may also directly or indirectly affect any transport or delivery equipment used to convey the beneficiated clay viscosifying additives to a well site or downhole such as, for example, any transport vessels, conduits, pipelines, trucks, tubulars, and/or pipes used to fluidically move the beneficiated clay viscosifying additives from one location to another, any pumps, compressors, or motors (e.g., topside or downhole) used to drive the beneficiated clay viscosifying additives into motion, any valves or related joints used to regulate the pressure or flow rate of the beneficiated clay viscosifying additives, and any sensors (i.e., pressure and temperature), gauges, and/or combinations thereof, and the like. The disclosed beneficiated clay viscosifying additives may also directly or indirectly affect the various downhole equipment and tools that may come into contact with the chemicals/fluids such as, but not limited to, drill string, coiled tubing, drill pipe, drill collars, mud motors, downhole motors and/or pumps, floats,

MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein.

Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A beneficiated clay viscosifying additive comprising:
a low-quality clay;
a polymer coated high-quality clay that comprises a high-quality clay at least partially coated with a polymer; and
wherein the ratio of low-quality clay to high-quality clay is about 90:10 to about 80:20 by weight.

2. The beneficiated clay viscosifying additive of claim 1, wherein the high-quality clay has an Fe³⁺:Fe²⁺ ratio of about 1 or greater.

3. The beneficiated clay viscosifying additive of claim 1, wherein the low-quality clay has an Fe³⁺:Fe²⁺ ratio of less than about 1.

4. The beneficiated clay viscosifying additive of claim 1, wherein the high-quality clay has an average particle size of about 1 micron to about 80 microns.

5. The beneficiated clay viscosifying additive of claim 1, wherein the high-quality clay is hectoite.

6. The beneficiated clay viscosifying additive of claim 1, wherein the high-quality clay has an average particle size less than an average particle size of the low-quality clay.

7. The beneficiated clay viscosifying additive of claim 1, wherein the polymer comprises at least one selected from the group consisting of a polysaccharide, a polyacrylamide, a polyalkylacrylamide, a polyacrylic acid, a polyvinyl alcohol, a polyanionic cellulose, any derivative thereof, a copolymer thereof, and any combination thereof.

8. The beneficiated clay viscosifying additive of claim 1, wherein the polymer coated high-quality clay is formed by dry coating the high-quality clay with the polymer.

9. A treatment fluid comprising the beneficiated clay viscosifying additive of claim 9.

10. The treatment fluid of claim 9, wherein the beneficiated clay viscosifying additive is present in the treatment fluid in a total amount ranging from about 0.1 pounds per barrel to about 20 pounds per barrel.

11. The method of claim 1 further comprising:
drilling at least a portion of a wellbore with the drilling fluid.

12. A beneficiated clay viscosifying additive comprising:
a low-quality clay having an Fe³⁺:Fe²⁺ ratio of less than about 1;
a polymer coated high-quality clay that comprises a high-quality clay at least partially coated with a polymer, the high-quality clay having an Fe³⁺:Fe²⁺ ratio of about 1 or greater;
wherein the high-quality clay has an average particle size less than an average particle size of the low-quality clay; and
wherein the ratio of low-quality clay to high-quality clay is about 90:10 to about 80:20 by weight.

13. A method comprising:
dry coating a high-quality clay with a polymer to yield a polymer coated high-quality clay; and
mixing the polymer coated high-quality clay with a low-quality clay to yield a beneficiated clay viscosifying additive, wherein the low-quality clay and the high-quality clay are at about 90:10 to about 80:20 by weight.

14. The method of claim 13, wherein the high-quality clay has an Fe³⁺:Fe²⁺ ratio of about 1 or greater.

15. The method of claim 13, wherein the low-quality clay has an Fe³⁺:Fe²⁺ ratio of less than about 1.

16. The method of claim 13, wherein the high-quality clay has an average particle size of about 1 micron to about 80 microns.

17. The method of claim 13, wherein the high-quality clay has an average particle size less than an average particle size of the low-quality clay.

18. The method of claim 13, wherein the polymer comprises at least one selected from the group consisting of a polysaccharide, a polyacrylamide, a polyalkylacrylamide, a polyacrylic acid, a polyvinyl alcohol, a polyanionic cellulose, any derivative thereof, a copolymer thereof, and any combination thereof.

19. The method of claim 13, wherein the polymer coated high-quality clay is formed by dry coating the high-quality clay with the polymer.

20. The method of claim 13 further comprising:
mixing the beneficiated clay viscosifying additive with an aqueous base fluid to yield a treatment fluid.
